(19) United States
(12) Patent Application Publication
(10) Pub. No.: US 2012/0043336 A1
(43) Pub. Date: Feb. 23, 2012

(54) Container Assembly with Removable Lid

(75) Inventor: Steve Grider, West Dundee, IL (US)

(73) Assignee: WKI HOLDING COMPANY, INC., Rosemont, IL (US)

(21) Appl. No.: 12/861,578

(22) Filed: Aug. 23, 2010

(51) Int. Cl. A47J 37/00; B23P 19/04; B65D 41/16

(52) U.S. Cl. 220/573.1; 220/780; 29/428

(57) ABSTRACT

A container assembly comprised of a cooking receptacle, and a removable lid. The cooking receptacle has a base and a sidewall connected to the base. The sidewall terminates at a peripheral edge. A first handle ledge has a first opening and projects from the peripheral edge. A second handle ledge has a second opening and projects from the peripheral edge. The removable lid has a cover portion and a seal portion with a continuous inner sidewall and a discontinuous outer sidewall that protrude toward the base of the cooking receptacle. A portion of the peripheral edge is disposed between the inner sidewall and the outer sidewall of the removable lid. A first outer sidewall portion of the seal portion is disposed within the first opening of the first handle ledge. A second outer sidewall portion of the seal portion is disposed within the second opening of the second handle ledge.

### TECHNICAL FIELD

The present invention relates to a container assembly, and more particularly, to a container assembly with a removable lid.

### BACKGROUND OF THE INVENTION

When storing leftover food, food that is to be prepared at a later time, or food that is to be served at a later time, it is common to use a container assembly that comprises a cooking vessel, or a storage vessel, and a lid that is removably securable to the cooking vessel. Although such container assemblies have existed for a long period of time, they have had some limitations. For example, a user may oftentimes not be able to easily grip such an assembly because the lid typically engulfs the entire perimeter of the cooking vessel, including any handles of the cooking vessel.

Thus, a need exists to provide a container assembly having a removable lid with an improved attachment arrangement to a cooking vessel.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to one embodiment, a container assembly is provided. The container assembly comprises a cooking receptacle, and a removable lid. The cooking receptacle has a base and a continuous sidewall connected to the base. The sidewall extends upward from the base and terminates at a peripheral edge. A first handle ledge projects laterally outward from the peripheral edge. The first handle ledge has a first opening formed therein. A second handle ledge projects laterally outward from the peripheral edge in a direction generally opposed to the first handle ledge. The second handle ledge has a second opening formed therein. The removable lid has a cover portion and a seal portion. The seal portion has a continuous inner sidewall that protrudes from the cover portion toward the base of the cooking receptacle. A discontinuous outer sidewall extends downward proximate a perimeter of the lid portion. The discontinuous outer sidewall comprises at least a first outer sidewall portion that protrudes from the cover portion toward the base of the cooking receptacle, and an opposed second outer sidewall portion that protrudes from the cover portion toward the base of the cooking receptacle. The peripheral edge of the cooking receptacle is disposed between the inner sidewall and the outer sidewall of removable lid. The first outer sidewall portion of the seal portion is disposed within the first opening of the first handle ledge. The second outer sidewall of the seal portion is disposed within the second opening of the second handle ledge.

According to one process, a method of forming a container assembly having a seal is provided. A cooking vessel having a base and a continuous sidewall is provided. The continuous sidewall terminates at an upper peripheral edge. A first handle ledge projects laterally from the upper peripheral edge. The first handle ledge has a first opening formed therein. A second handle ledge projects laterally from the upper peripheral edge in a direction generally opposed to the first handle ledge. The second handle ledge has a second opening formed therein. A removable lid having a seal portion and a central cover portion is provided. The seal portion has a continuous inner sidewall that projects downward from the cover portion. A discontinuous outer sidewall comprises a first outer sidewall portion that projects downward from the cover portion and a second outer sidewall portion that projects downward from the cover portion. The removable lid is aligned with the cooking vessel. The removable lid is secured to the cooking vessel such that the upper peripheral edge of the cooking vessel is disposed between the inner sidewall of the removable lid and the first outer sidewall portion of the removable lid, the first outer sidewall portion of the lid is disposed within the first opening of the first handle ledge, and the second outer sidewall portion of the lid is disposed within the second opening of the second handle ledge.

According to another embodiment, a removable lid with a seal for use with a cooking receptacle that has a base and a continuous sidewall connected to the base is provided. The lid comprises a cover portion and a seal portion. The seal portion has a continuous inner sidewall that protrudes downward from the cover portion. A discontinuous outer sidewall comprises a first outer sidewall portion that protrudes downward from the cover portion, a second outer sidewall portion that protrudes downward from the cover portion, a third outer sidewall portion that protrudes downward from the cover portion, and a fourth outer sidewall portion that protrudes downward from the cover portion. A generally horizontal ledge separates the inner sidewall from the outer sidewall. A first gap exists between the first outer sidewall portion and the second outer sidewall portion. A second gap exists between the second outer sidewall portion and the third outer sidewall portion. A third gap exists between the third outer sidewall portion and the fourth outer sidewall portion. A fourth gap exists between the fourth outer sidewall portion and the first outer sidewall portion.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a pictorial view of a container assembly according to one embodiment;

FIG. 2 is a side view of the container assembly of FIG. 1;

FIG. 3 is an end view of the container assembly of FIG. 1;

FIG. 4 is a top pictorial view of a lid for a container assembly according to one embodiment;

FIG. 5 is a bottom pictorial view of the lid of FIG. 4;

FIG. 6 is a pictorial view of a cooking vessel;

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

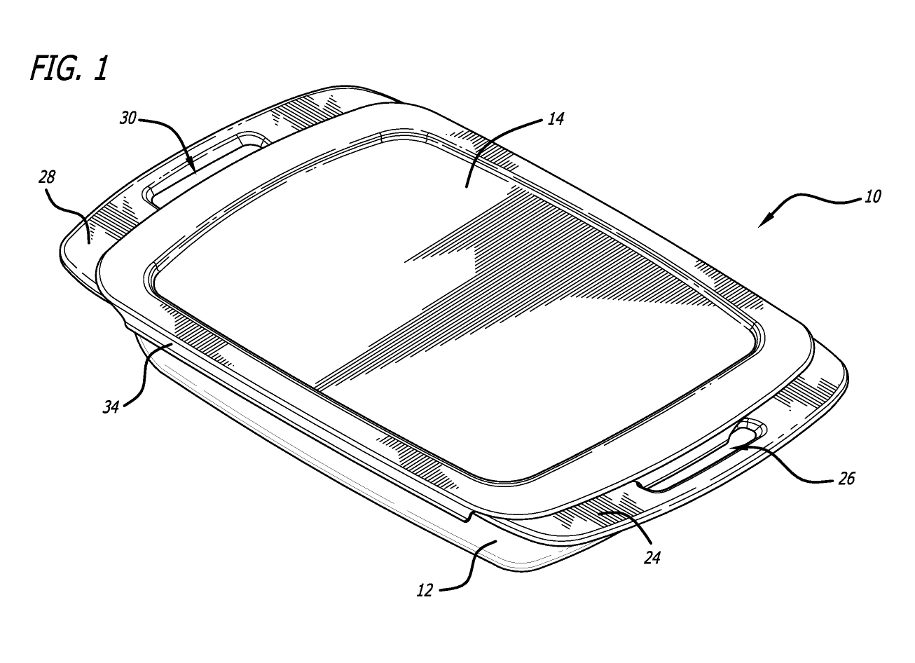

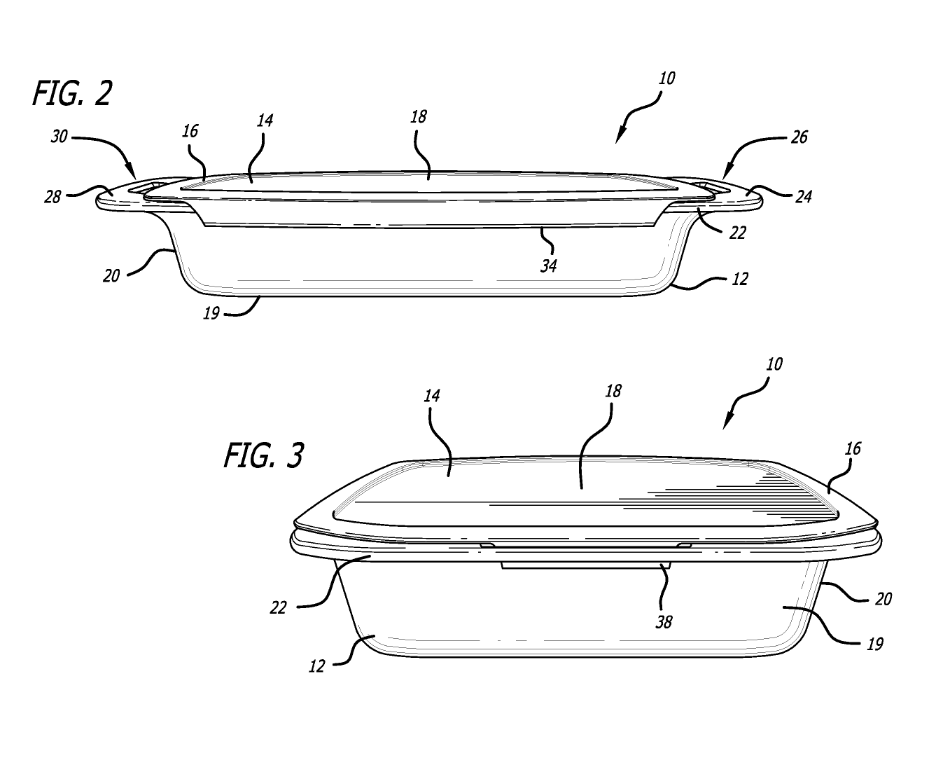

According to one embodiment of the present invention, as shown in FIGS. 1-3, a container assembly 10 is provided. As will be discussed below, according to one aspect of the invention, the container assembly 10 comprises a cooking vessel 12, and a lid portion 14. The cooking vessel 12 comprises a base portion 19 and a continuous sidewall 20 projecting upward from the base portion 19. The sidewall 20 begins at the base portion 19 and terminates at an upper peripheral edge 22. It is contemplated that the base portion 19 of the cooking vessel 12 may be provided in a variety of shapes, such as rectangular, as shown in FIG. 1, a square, a triangle, an oval, a circle, or any other shape into which a container may be configured. It is further contemplated that the edge 22 of the sidewall 20 will generally be rounded. Providing a rounded edge 22 enhances the aesthetics of the cooking vessel 12, reduces the likelihood of damaging the upper peripheral edge 22 from contact with other objects, and increases the user's comfort while handling the cooking vessel 12. Additionally, a rounded upper peripheral flange 22 reduces the wear on a region of the lid portion 14 that contacts the upper peripheral flange 22 and also decreases the likelihood of a user being cut by the cooking vessel 12. A rounded edge may also increase the strength of the upper peripheral edge 22 by providing a greater amount of material in that location, thus reducing the likelihood of breaking the cooking vessel 12.

A first handle ledge 24 projects outwardly from the upper peripheral edge 22. The first handle ledge 24 provides a user with an area to grasp the cooking vessel 12. The first handle ledge 24 has a first opening 26 formed therein. The first opening 26 may allow a user to place a portion of their hand into the first opening 26 when grasping or carrying the cooking vessel 12.

A second handle ledge 28 projects outwardly from the upper peripheral edge 22. The second handle ledge 28 provides a user with an area to grasp of the cooking vessel 12. The second handle ledge 28 has a second opening 30 formed therein. The second opening 30 may allow a user to place a portion of their hand into the first opening 28 when grasping or carrying the cooking vessel 12.

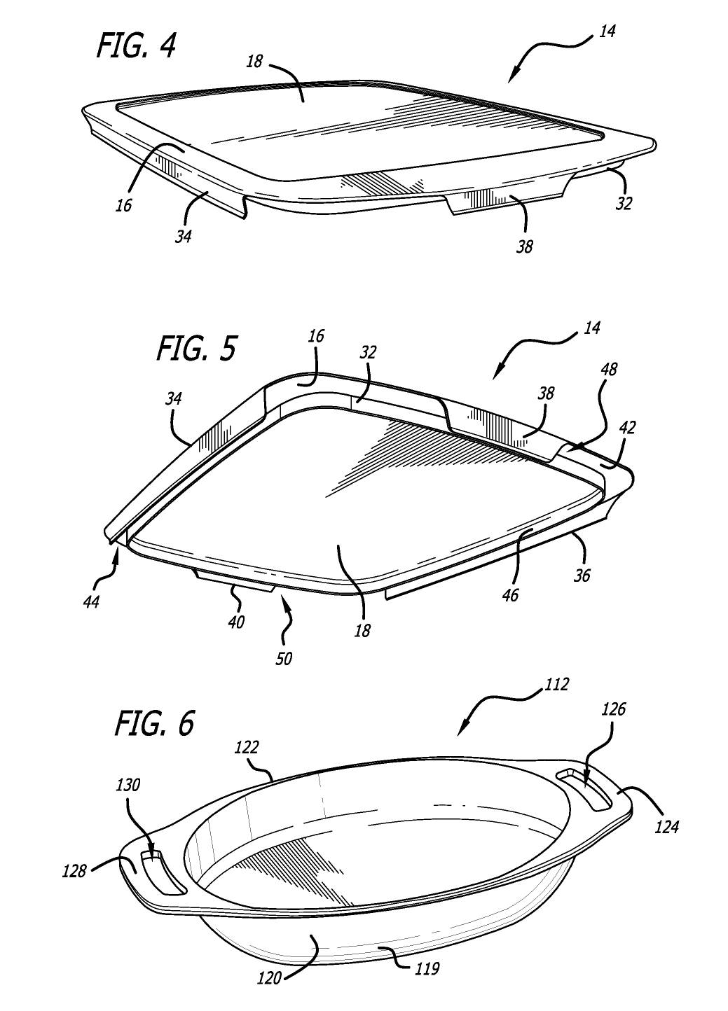

As shown in FIGS. 1-5, the lid portion 14 has a seal portion 16 and a central cover portion 18. The central cover portion 18 is disposed inwardly of the seal portion 16. The central cover portion 18 is generally sized to correspond with the upper peripheral edge 22 of the cooking vessel 12 such that central cover portion 18 completely covers the upper peripheral edge 22.

As best seen in FIG. 5, the seal portion 16 has an inner sidewall 32 extending downward from the central cover portion 18. The inner sidewall 32 is a continuous wall and forms a perimeter on a bottom side of the lid portion 14. The perimeter formed by the inner sidewall 32 generally corresponds to a perimeter formed by the upper peripheral edge 22 of the sidewall 20 of the cooking vessel 12 for which the lid portion 14 is used. It is contemplated that an outer side of the inner sidewall 32 contacts an inner side of the sidewall 20.

The seal portion additionally has a first outer sidewall 34 that extends downward from the central cover portion 18. A second outer sidewall 36 extends downward from the central cover portion 18. The second outer sidewall 36 is on a side of the lid portion 14 that is generally opposite the first outer sidewall 34. The second outer sidewall 36 is arranged in a generally parallel manner to the first outer sidewall 34. A third outer sidewall 38 extends downward from the central cover portion 18. The third outer sidewall 38 is arranged in a generally normal orientation to both the first outer sidewall 34 and the second outer sidewall 36. A fourth outer sidewall 40 also extends downward from the central cover portion 18. The fourth outer sidewall 40 is on a side of the lid portion 14 that is generally opposite the third outer sidewall 38. The first, second, third, and fourth outer sidewall 34, 36, 38, 40 are separated from the inner sidewall 32 by a generally horizontal ledge 42. The width of the ledge 42 is generally equivalent to a thickness of the upper peripheral edge 22 of the sidewall 20 of the cooking vessel 12.

A first receiving channel 44 is formed between the inner sidewall 32 and the first outer sidewall 34, a second receiving channel 46 is formed between the inner sidewall 32 and the second outer sidewall 36, a third receiving channel 48 is formed between the inner sidewall 32 and the third outer sidewall 38, and a fourth receiving channel 50 is formed between the inner sidewall 32 and the fourth outer sidewall 40. The receiving channels 44, 46, 48, 50 are adapted to receive upper peripheral edge 22 of the sidewall 20 of the cooking vessel 12. A press fit or friction fit may exist between a portion of the sidewall 20 of the cooking vessel 12 and the receiving channels 44, 46, 48, 50 in that the outer sidewalls 34, 36, 38, 40 of the lid portion 14 may be deformed outward by the sidewall 20 of the cooking vessel 12. It is contemplated that a width of the receiving channels 44, 46, 48, 50 is greater near the cover portion 18 and decreases towards the termination of the sidewalls 32, 34, 36, 38, 40.

The third outer sidewall 38 is received by the first opening 26 of the first handle ledge 24, while the fourth outer sidewall 40 is received by the second opening 30 of the second handle ledge 28. Thus, the lid portion 14 allows a user to access a portion of the first handle ledge 24 and the second handle ledge 28 without having to touch the lid portion 14. This enhances the user's ability to grasp the container assembly 10, as the user is not having to hold a removable component, the lid portion 14, while holding the container assembly 10, but rather may simply hold the first and second handle ledge portions 24, 28 of the cooking vessel 12. Additionally, the lid portion 14 is less likely to be inadvertently removed from the container assembly 10 when a user is able to grasp the first and second handle ledge portion 24, 28 even with the lid portion 14 attached. Further, the user is even able to utilize the first opening 26 of the first handle ledge 24 and the second opening 30 of the second handle ledge 28 when the lid portion 14 is attached.

Thus, the container assembly 10 has a lid portion 14 with a continuous inner sidewall 32 and a plurality of discontinuous outer sidewalls 34, 36, 38, 40 that form a seal portion 16 that seals and attaches the lid portion 14 to the cooking vessel 12. The outer sidewalls 34, 36, 38, 40 are discontinuous in that a first gap exists between the first outer sidewall 34 and the second outer sidewall 36, a second gap exists between the second outer sidewall 36 and the third outer sidewall 38, a third gap exists between the third outer sidewall 38 and the fourth outer sidewall 40, and a fourth gap exists between the fourth outer sidewall 40 and the first outer sidewall 34.

Thus, to form the container assembly 10, the lid portion 14 is provided above the cooking vessel 12. The lid portion 14 contacts the cooking vessel 12 such that the inner sidewall 32 contacts an inner surface of the sidewall 20 of the container, while an outer surface of the sidewall 20 contacts the outer sidewalls 34, 36, 38, 40 of the lid portion. The edge 22 of the sidewall 20 of the cooking vessel 12 is disposed between the inner sidewall 32 and the outer sidewalls 34, 36, 38, 40 of the lid portion in a plurality of channels 44, 46, 48, 50. The third outer sidewall 38 extends into the first opening 26 of the first handle ledge 24, while the fourth outer sidewall 40 extends into the second opening 30 of the second handle ledge 28.

Thus, the lid portion 14 restricts the contents of the container assembly 10 from leaking out and limits the ability of undesired materials to enter the container assembly 10.

FIG. 6 shows another embodiment of a cooking vessel 112. The cooking vessel 112 comprises a base portion 119 and a continuous sidewall 120 projecting upward from the base portion 119. The sidewall 120 begins at the base portion 119 and terminates at an upper peripheral edge 122. FIG. 6 shows that the base portion 119 of the cooking vessel 112 has a generally oval or elongate shape. It is further contemplated that the edge 122 of the sidewall 120 will generally be rounded.

A first handle ledge 124 projects outwardly from the upper peripheral edge 122. The first handle ledge 124 provides a user with an area to grasp the cooking vessel 112. The first handle ledge 124 has a first opening 126 formed therein. The first opening 126 may allow a user to place a portion of their hand into the first opening 126 when grasping or carrying the cooking vessel 112.

A second handle ledge 128 projects outwardly from the upper peripheral edge 122. The second handle ledge 128 provides a user with an area to grasp the cooking vessel 112. The second handle ledge 128 has a second opening 130 formed therein. The second opening 130 may allow a user to place a portion of their hand into the first opening 128 when grasping or carrying the cooking vessel 112.

While specific embodiments have been illustrated and described, numerous modifications come to mind without significantly departing from the spirit of the invention, and the scope of protection is only limited by the scope of the accompanying Claims.

What is claimed is:

1. A container assembly comprising:
a cooking receptacle having a base and a continuous sidewall connected to the base, the sidewall extending upward from the base and terminating at a peripheral edge, a first handle ledge projecting laterally outward from the peripheral edge, the first handle ledge having a first opening formed therein, and a second handle ledge projecting laterally outward from the peripheral edge in a direction generally opposed to the first handle ledge, the second handle ledge having a second opening formed therein; and
a removable lid having a cover portion and a seal portion, the seal portion having a continuous inner sidewall protruding from the cover portion toward the base of the cooking receptacle, a discontinuous outer sidewall extending downward proximate a perimeter of the removable lid, the discontinuous outer sidewall comprising at least a first outer sidewall portion protruding from the cover portion toward the base of the cooking receptacle, and an opposed second outer sidewall portion protruding from the cover portion toward the base of the cooking receptacle, the peripheral edge of the cooking receptacle disposed between the inner sidewall and the outer sidewall of the removable lid;
wherein the first outer sidewall portion of the seal portion is disposed within the first opening of the first handle ledge, and the second outer sidewall portion of the seal portion is disposed within the second opening of the second handle ledge.

2. The container assembly of claim 1, wherein the inner sidewall of the lid portion contacts the sidewall of the cooking receptacle.

3. The container assembly of claim 1, wherein a generally horizontal ledge separates the inner sidewall of the lid portion and the first outer sidewall portion of the lid portion.

4. The container assembly of claim 3, wherein the generally horizontal ledge has a width generally equal to a thickness of the peripheral edge of the sidewall of the cooking vessel.

5. The container assembly of claim 1, wherein a distance between the inner sidewall of the lid portion and the outer sidewall of the lid portion is greatest adjacent to the cover portion of the lid portion

6. The container assembly of claim 1, wherein the first outer sidewall portion of the lid portion displaces outwardly when contacting the sidewall of the cooking vessel.

7. The container assembly of claim 1, wherein a first receiving channel forms between the inner sidewall of the lid portion and the first outer sidewall portion of the lid portion, the receiving channel having a thickness adapted to receive a portion of the sidewall of the cooking vessel.

8. The container assembly of claim 1, wherein the first outer sidewall portion is disposed on a generally opposite side of the removable lid as the second outer sidewall portion.

9. The container assembly of claim 1, wherein the removable lid further comprises a third outer sidewall portion protruding from the cover portion toward the base of the cooking receptacle and a fourth outer sidewall portion protruding from the cover portion toward the base of the cooking receptacle.

10. The container assembly of claim 9, wherein the third outer sidewall portion is disposed on a generally opposite side of the removable lid as the fourth outer sidewall portion.

11. The container assembly of claim 9, wherein the third outer sidewall portion is longer than the first outer sidewall portion.

12. A method of forming a container assembly having a seal, comprising:
providing a cooking vessel having a base and a continuous sidewall, the continuous sidewall terminating at an upper peripheral edge, a first handle ledge projecting laterally from the upper peripheral edge, the first handle ledge having a first opening formed therein, a second handle ledge projecting laterally from the upper peripheral edge in a direction generally opposed to the first handle ledge, the second handle ledge having a second opening formed therein;
providing a removable lid having a seal portion and a central cover portion, the seal portion having a continuous inner sidewall project downward from the cover portion, and a discontinuous outer sidewall comprising a first outer sidewall portion projecting downward from the cover portion, and a second outer sidewall portion projecting downward from the cover portion;
aligning the removable lid with the cooking vessel; and
securing the removable lid to the cooking vessel such that the upper peripheral edge of the cooking vessel is disposed between the inner sidewall of the removable lid and the first outer sidewall portion of the removable lid and the first outer sidewall portion of the lid is disposed within the first opening of the first handle ledge, and the second outer sidewall portion of the lid is disposed within the second opening of the second handle ledge.

13. The method of claim 12, wherein the discontinuous outer sidewall of the lid portion further comprises a third outer sidewall portion, the upper peripheral edge of the cooking vessel is disposed between the inner sidewall of the removable lid and the third outer sidewall portion of the lid when securing the removable lid to the cooking vessel.

14. The method of claim 12, wherein the sidewall of the cooking vessel displaces the third outer sidewall portion of the removable lid away from the inner sidewall of the removable lid.

15. The method of claim 12, wherein the sidewall of the cooking vessel displaces the first outer sidewall portion of the removable lid away from the inner sidewall of the removable lid.

16. The method of claim 15, wherein the sidewall of the cooking vessel displaces the second outer sidewall portion of the removable lid away from the inner sidewall of the removable lid.

17. A removable lid with a seal for use with a cooking receptacle having a base and a continuous sidewall connected to the base, the lid comprising:
a cover portion; and
a seal portion, the seal portion having a continuous inner sidewall protruding downward from the cover portion, a discontinuous outer sidewall comprising a first outer sidewall portion protruding downward from the cover portion, a second outer sidewall portion protruding downward from the cover portion, a third outer sidewall portion protruding downward from the cover portion, a fourth outer sidewall portion protruding downward from the cover portion, and a generally horizontal ledge separating the inner sidewall from the outer sidewall;
wherein a first gap exists between the first outer sidewall portion and the second outer sidewall portion, a second gap exists between the second outer sidewall portion and the third outer sidewall portion, a third gap exists between the third outer sidewall portion and the fourth outer sidewall portion, and a fourth gap exists between the fourth outer sidewall portion and the first outer sidewall portion.

18. The removable lid of claim 17, wherein a first receiving channel being formed between the continuous inner sidewall and the first outer sidewall portion, a second receiving channel being formed between the continuous inner sidewall and the second outer sidewall portion, a third receiving channel being formed between the continuous inner sidewall and the third outer sidewall portion, and a fourth receiving channel being formed between the continuous inner sidewall and the fourth outer sidewall portion.

19. The removable lid of claim 18, wherein the first outer sidewall portion is longer than the second outer sidewall portion.

20. The removable lid of claim 18, wherein the first outer sidewall portion is generally normal to the second outer sidewall portion.
